(19) United States
(12) Patent Application Publication
(10) Pub. No.: US 2016/0196683 A1
(43) Pub. Date: Jul. 7, 2016

(54) SIMULATION APPARATUS AND VECTOR DISPLAY METHOD

(71) Applicant: FUJITSU LIMITED, Kawasaki-shi (JP)

(72) Inventors: Takao Hirahara, Kawasaki (JP); MASAHIRO WATANABE, Kawasaki (JP)

(73) Assignee: FUJITSU LIMITED, Kawasaki-shi (JP)

(21) Appl. No.: 14/945,162

(22) Filed: Nov. 18, 2015

(30) Foreign Application Priority Data
Jan. 5, 2015 (JP) 2015-000231

(51) Int. Cl. G06T 15/06; G06T 17/00

(52) U.S. Cl. CPC G06T 15/06; G06T 17/00

(57) ABSTRACT

A memory stores vector data indicative of a vector at each of a plurality of positions on a model. A processor calculates a plurality of points on the model which are arranged spirally. When the processor displays a plurality of objects corresponding to a plurality of vectors indicated in the vector data, the processor changes display positions of at least part of the plurality of objects from positions indicated in the vector data on the basis of the plurality of points calculated.

### CROSS-REFERENCE TO RELATED APPLICATION

This application is based upon and claims the benefit of priority of the prior Japanese Patent Application No. 2015-000231, filed on Jan. 5, 2015, the entire contents of which are incorporated herein by reference.

### FIELD

The embodiments discussed herein are related to a simulation apparatus and a vector display method.

### BACKGROUND

With the improvement of the calculation capability of computers, various physical phenomena are simulated by using them. For example, the distribution of stress or magnetic force on the surface of a body may be simulated by the use of a computer. A simulation result may be obtained as vector data in which vectors indicative of a physical amount, such as stress or magnetic force, at a plurality of positions on a model are recorded.

When users confirm simulation results, they may want to see an image obtained by visualizing vector data as numeric values rather than read the vector data. A method for visualizing vector data may be to arrange objects corresponding to vectors in model space and display on a display unit an image obtained at the time of viewing the objects from an observation point. For example, arrows having directions and length corresponding to the vectors are used as the objects.

A fisheye magnification display method which eliminates an overlap between figures at the time of displaying a plurality of plane figures on a display unit is proposed. This fisheye magnification display method is as follows. A straight line indicative of an area in which figures are densely arranged is detected and the distance (first distance) between the straight line and each figure and the distance (second distance) between the straight line and a screen edge are calculated. On the basis of the first distance, the second distance, and a parameter, each figure is then moved toward the screen edge so that it will be distant from the straight line.

Furthermore, a three-dimensional fisheye magnification display method which eliminates, at the time of displaying on a display unit an image observed in model space in which a plurality of solid figures are arranged, an overlap between figures in the image is proposed. This three-dimensional fisheye magnification display method is as follows. A straight line is designated in the model space and the distance (first distance) between a plane which includes the straight line and an observation point and each figure and the distance (second distance) between the above plane and a model space edge are calculated. On the basis of the first distance and the second distance, each figure is then moved toward the model space edge so that it will be distant from the above plane.

See, for example, Japanese Laid-open Patent Publication Nos. 10-240961 and 11-154247.

If vector data as a simulation result is visualized by the use of a plurality of objects, objects may overlap in an image. For example, it is assumed that objects corresponding to vectors are arranged in three-dimensional model space at positions indicated in vector data and that those objects are observed from an observation point. In this case, if a second object is arranged on a prolongation of a segment which connects the observation point and an object near the observation point, at least part of the second object is hidden by the object in an image. As a result, it is difficult to confirm the direction or magnitude of a vector at a position distant from the observation point. Accordingly, the visibility of an image in which vector data is visualized becomes lower.

### SUMMARY

According to an aspect, there is provided a non-transitory computer-readable storage medium storing a program that causes a computer to perform a process including: acquiring vector data indicative of a vector at each of a plurality of positions on a model, calculating a plurality of points on the model which are arranged spirally, and changing, at the time of displaying a plurality of objects corresponding to a plurality of vectors indicated in the vector data, display positions of at least part of the plurality of objects from positions indicated in the vector data on the basis of the plurality of points calculated.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a simulation apparatus according to a first embodiment;

FIG. 2 is a block diagram of an example of hardware of a simulation apparatus;

FIG. 3 illustrates an example of moving objects at visualization time;

FIG. 4 illustrates an example of a Fibonacci spiral and a Fibonacci point;

FIG. 5 illustrates an example of the display of rearranged objects;

FIG. 6 is a block diagram which illustrates an example of the function of the simulation apparatus;

FIG. 7 illustrates an example of a vector table;

FIG. 8 illustrates an example of a Fibonacci point table;

FIG. 9 is a flow chart of an example of a procedure for position adjustment;

FIG. 10 is a flow chart of an example of a procedure for object movement;

FIG. 11 illustrates an example of a curve which connects Fibonacci points; and

FIG. 12 is a flow chart of an example of another procedure for object movement.

### DESCRIPTION OF EMBODIMENTS

Embodiments will now be described with reference to the accompanying drawings, wherein like reference numerals refer to like elements throughout.

### First Embodiment

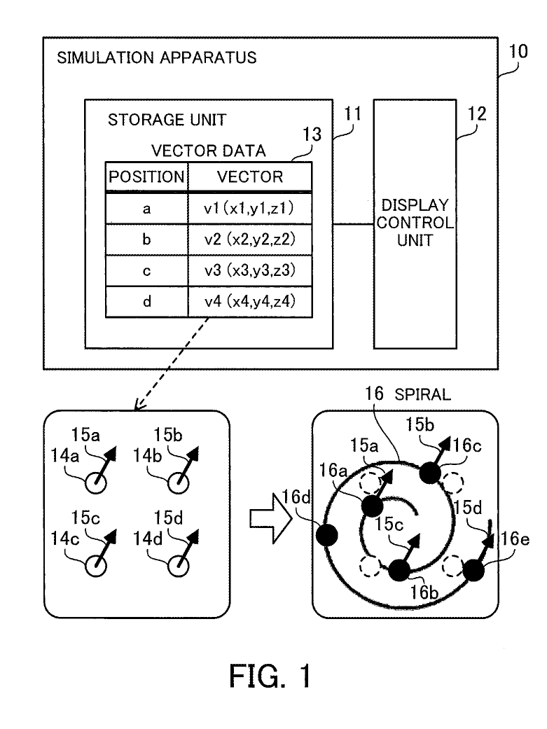

FIG. 1 illustrates a simulation apparatus according to a first embodiment.

A simulation apparatus 10 according to a first embodiment does various simulations such as scientific technology simulations. For example, the simulation apparatus 10 acquires a model indicative of the structure of a body and simulates the distribution of a physical amount, such as stress or magnetic force, on the surface of or in the inside of the body. A calculated physical amount, such as stress or magnetic force, is represented as a vector. If a three-dimensional model is used, a physical amount is represented as a three-dimensional vector. The simulation apparatus 10 then visualizes a simulation result. For example, the simulation apparatus 10 generates an image indicative of a simulation result and makes a display unit (not illustrated) connected to the simulation apparatus 10 display the image.

The simulation apparatus 10 includes a storage unit 11 and a display control unit 12. The storage unit 11 stores vector data 13 indicative of a simulation result. The storage unit 11 may be a volatile memory, such as a random access memory (RAM), or nonvolatile storage, such as a hard disk drive (HDD) or a flash memory. The display control unit 12 visualizes the vector data 13 stored in the storage unit 11. The display control unit 12 may be a processor, such as a central processing unit (CPU) or a digital signal processor (DSP). Furthermore, the display control unit 12 may include a specific purpose electronic circuit, such as an application specific integrated circuit (ASIC) or a field programmable gate array (FPGA). A processor executes a program stored in a memory, such as a RAM. A set of processors (multiprocessor) may be referred to as a “processor”.

In the vector data 13, a plurality of positions on a model are associated with a plurality of vectors calculated and these positions and vectors are recorded. The vector data 13 represents a physical amount at each of the plurality of positions as a vector. Each position is represented by the use of, for example, three-dimensional coordinates. Each vector is represented as, for example, a combination of a floating-point number of an x component, a floating-point number of a y component, and a floating-point number of a z component. The direction and magnitude of a physical amount, such as stress or magnetic force, are represented by a vector. As an example, discrete positions 14a, 14b, 14c, and 14d are sampled from the model. In this case, the vector data 13 includes a vector v1 corresponding to the position 14a, a vector v2 corresponding to the position 14b, a vector v3 corresponding to the position 14c, and a vector v4 corresponding to the position 14d.

The display control unit 12 acquires the vector data 13 from the storage unit 11. Furthermore, the display control unit 12 calculates on a model a plurality of points spirally arranged. The center of a spiral 16 is determined by any method. For example, the center of the spiral 16 is the center of a visualized model area. As an example, the display control unit 12 calculates points 16a, 16b, 16c, 16d, and 16e which form the spiral 16. The point 16a is near the position 14a, the point 16b is near the position 14c, the point 16c is near the position 14b, and the point 16e is near the position 14d. It is desirable to calculate the plurality of points which form the spiral 16 so that two adjacent points will be a golden angle distant from each other. It is assumed that a golden ratio is R_{g}. Then a golden angle is about 137.508° (=360°÷(1+R_{g})). The points having this property may safely be referred to as “Fibonacci points” and the spiral 16 formed in that case is referred to as a “Fibonacci spiral”.

A model on which objects are arranged at Fibonacci points whose two adjacent points are the golden angle distant from each other has the property of the probability that when those objects are viewed from any observation point, objects are visible in a state in which they overlap being low. The arrangement of objects by the use of the golden angle is a phenomenon which also takes place in the natural world such as the arrangement of the leaves of plants. Accordingly, the display control unit 12 may visualize the vector data 13 by utilizing the property of a Fibonacci spiral and Fibonacci points. Instead of calculating a plurality of points whose two adjacent points are the exact golden angle distant from each other, however, the display control unit 12 may calculate a plurality of points whose two adjacent points are an angle (about 135 to 140°, for example) close to the golden angle distant from each other. Furthermore, the display control unit 12 may calculate a plurality of points whose two adjacent points are a determined angle distant from each other.

The display control unit 12 then visualizes the vector data 13. At this time the display control unit 12 arranges a plurality of objects corresponding to the plurality of vectors indicated in the vector data 13 on a model. Each object has a shape corresponding to the direction and magnitude of a vector. For example, an arrow whose direction and length are variable may be used as an object. An initial value of the display position of an object is a position indicated in the vector data 13.

As an example, an object 15a corresponding to the vector v1 is arranged at the position 14a on the model. An object 15b corresponding to the vector v2 is arranged at the position 14b on the model. An object 15c corresponding to the vector v3 is arranged at the position 14c on the model. An object 15d corresponding to the vector v4 is arranged at the position 14d on the model. For example, the display control unit 12 sets an observation point over a plane on which the objects are arranged, and generates an image by observing the set of objects diagonally from above. For example, the display control unit 12 makes the display unit display the generated image.

However, if the display control unit 12 determines the display positions of the objects in accordance with the vector data 13, the possibility that objects will be visible in an image in a state in which they overlap increases with an increase in the number of the objects. Accordingly, the display control unit 12 changes the display positions of at least part of the objects with the plurality of points which form the above spiral 16 as reference so as to prevent objects from overlapping in an image. The display control unit 12 may change the display position of an object after generating an image once or before generating an image. Furthermore, the display control unit 12 may change the display position of an object only if the number of all objects or the number of objects per unit area exceeds a threshold.

For example, the display control unit 12 selects the display position of each object from among the plurality of points which form the spiral 16. A selected point may be a point nearest a position indicated in the vector data 13. As an example, if the position 14a is near the point 16a, then the object 15a is moved from the position 14a to the point 16a. If the position 14b is near the point 16c, then the object 15b is moved from the position 14b to the point 16c. If the position 14c is near the point 16b, then the object 15c is moved from the position 14c to the point 16b. If the position 14d is near the point 16e, then the object 15d is moved from the position 14d to the point 16e.

With the simulation apparatus 10 according to the first embodiment the plurality of points which form the spiral 16 are calculated if the vector data 13 is visualized. The display positions of the plurality of objects corresponding to the plurality of vectors indicated in the vector data 13 are then changed from the original positions indicated in the vector data 13 with the points which form the spiral 16 as reference. This reduces the possibility that objects will be visible in an image in a state in which they overlap. Accordingly, it is easy to realize the direction or magnitude of a vector, and the visibility of a visualized image is improved. The property of a Fibonacci spiral can be utilized in particular if a plurality of points which form the spiral 16 are calculated so that two adjacent points of them will be the golden angle or an angle close to the golden angle distant from each other. This further reduces the possibility that objects will be visible in a state in which they overlap.

### Second Embodiment

A simulation apparatus 100 according to a second embodiment does scientific technology simulations by the use of a three-dimensional model inputted by a user, and calculates the distribution of a physical amount, such as stress or magnetic force. A simulation result includes a three-dimensional vector indicative of a physical amount at each of a plurality of positions on the model. The simulation apparatus 100 then visualizes the simulation result. The simulation apparatus 100 may be a client computer operated by the user or a server computer accessed via a network.

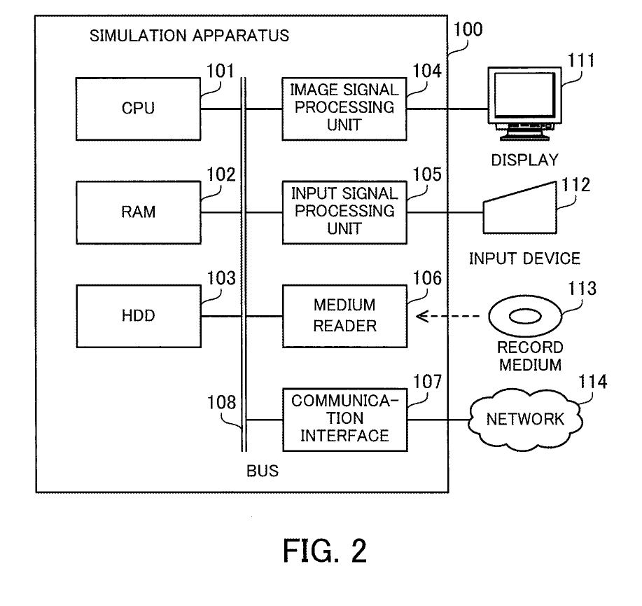

FIG. 2 is a block diagram of an example of hardware of the simulation apparatus.

The simulation apparatus 100 includes a CPU 101, a RAM 102, an HDD 103, an image signal processing unit 104, an input signal processing unit 105, a medium reader 106, and a communication interface 107. Each of the above units is connected to a bus 108.

The CPU 101 is a processor including an arithmetic circuit which executes a program instruction. The CPU 101 loads into the RAM 102 at least part of programs and data stored in the HDD 103, and executes the program. The CPU 101 may include plural processor cores. The simulation apparatus 100 may include plural processors. The process described in the following may be performed in parallel by the use of the plural processors or the plural processor cores. In addition, a set of processors (multiprocessor) may be referred to as a “processor”.

The RAM 102 is a volatile semiconductor memory which temporarily stores a program executed by the CPU 101 and data used by the CPU 101 for performing an operation. The simulation apparatus 100 may include a memory which differs from a RAM in type, and include plural memories.

The HDD 103 is a nonvolatile storage unit which stores programs of software, such as an operating system (OS), middleware, and application software, and data. The programs include a simulation program. The simulation apparatus 100 may include a storage unit of another type, such as a flash memory or a solid state drive (SSD), and include plural nonvolatile storage units.

The image signal processing unit 104 outputs an image to a display 111 connected to the simulation apparatus 100 in accordance with an instruction from the CPU 101. A cathode ray tube (CRT) display, a liquid crystal display (LCD), a plasma display panel (PDP), an Organic electro-luminescence (OEL) display, or the like is used as the display 111.

The input signal processing unit 105 acquires an input signal from an input device 112 connected to the simulation apparatus 100, and outputs it to the CPU 101. A pointing device, such as a mouse, a touch panel, a touch pad, or a track ball, a keyboard, a remote controller, a button switch, or the like is used as the input device 112. Furthermore, input devices of plural types may be connected to the simulation apparatus 100.

The medium reader 106 is a reader which reads a program or data recorded on a record medium 113. A magnetic disk such as a flexible disk (FD) or an HDD, an optical disk such as a compact disc (CD) or a digital versatile disc (DVD), a magneto-optical disk (MO), a semiconductor memory, or the like is used as the record medium 113. For example, the medium reader 106 stores in the RAM 102 or the HDD 103 a program or data which it reads from the record medium 113.

The communication interface 107 is connected to a network 114 and communicates with another computer. The communication interface 107 may be a wired communication interface connected to a communication device, such as a switch, via a cable or a radio communication interface connected to a base station or an access point via a radio link.

However, the simulation apparatus 100 may not include the medium reader 106. If the simulation apparatus 100 is a server computer accessed via the network 114, then the simulation apparatus 100 may not include the image signal processing unit 104 or the input signal processing unit 105. In addition, the display 111 or the input device 112 and an enclosure of the simulation apparatus 100 may be formed integrally. The CPU 101 is an example of the display control unit 12 in the first embodiment. The RAM 102 or the HDD 103 is an example of the storage unit 11 in the first embodiment.

Problems which arise in the case of visualizing vector data as a simulation result and a visualization method utilizing a Fibonacci spiral will now be described.

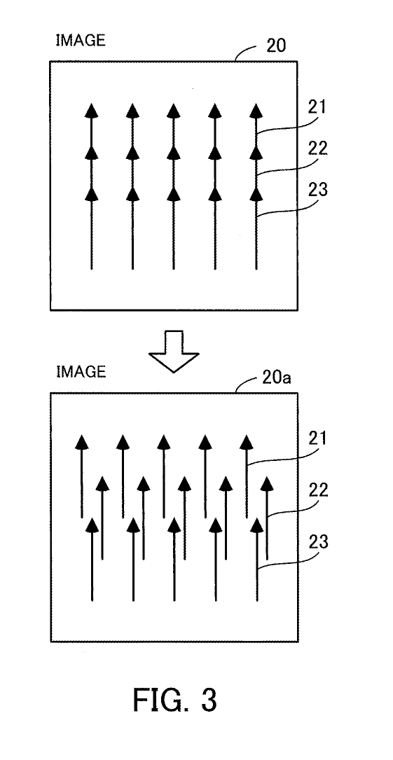

FIG. 3 illustrates an example of moving objects at visualization time.

The simulation apparatus 100 calculates a vector indicative of a physical amount for each of a plurality of discrete positions on a model. In order to visualize these simulation results, the simulation apparatus 100 arranges a plurality of objects corresponding to a plurality of vectors on the model. In the second embodiment an arrow corresponding to the direction and magnitude of a vector will be used as an object. In an initial state an object is arranged at an original position at which a vector corresponding to the object is calculated. Furthermore, the simulation apparatus 100 disposes a camera over the model. The direction of the camera may be designated by a user.

It is assumed mainly in the second embodiment that the plurality of objects are arranged on an x-y plane at z=z₀ (determined value) and that the camera is disposed at a position (whose z coordinate is greater than z₀) which overlooks the set of objects diagonally from above. The x-y plane corresponds to, for example, the surface of a body. In that case, the arranged objects represent the distribution of vectors on the surface of the body. Furthermore, the x-y plane corresponds to, for example, a section of a body. In that case, the arranged objects represent the distribution of vectors inside the body. The simulation apparatus 100 generates an image observed from the camera and displays the generated image on the display 111. As a result, it is expected that a user easily realizes the distribution of a physical amount.

However, if the vectors are sampled at regular intervals like a grid, an object near the camera and an object distant from the camera may be visible near the center of an image in a state in which they overlap. Furthermore, if an image is generated in the above way, then objects distant from the camera appear in perspective so that they will gather near the center of the image. As a result, the possibility that an object near the camera and an object distant from the camera will be visible in a state in which they overlap increases.

As an example, objects 21 through 23 as arrows appear in an image 20. Of the objects 21 through 23, the object 23 is nearest the camera, the object 22 is disposed one behind the object 23, and the object 21 is disposed one behind the object 22. According to the arrangement in the initial state, three arrows as the objects 21 through 23 are visible in the image 20 in a state in which they overlap in a straight line. Accordingly, it is not easy for the user to individually realize three vectors represented by the three arrows from the image 20.

Therefore, if there is an area on an initially generated image in which the number of objects per unit area (object density) is great, then the simulation apparatus 100 changes the arrangement of at least part of objects. The simulation apparatus 100 then regenerates an image on the basis of arrangement after the change and displays the regenerated image on the display 111.

As an example, the objects 21 through 23 as arrows appear in an image 20a. This is the same with the image 20. The image 20a is obtained by changing the arrangement of part of the objects in the image 20. The object 22 is moved to the right from the camera. The object 21 is moved to the left from the camera. According to arrangement after the change, the object 22 does not overlap the object 23 disposed on this side of the object 22, and the object 21 does not overlap the object 22 or 23 disposed on this side of the object 21. As a result, the user recognizes the three arrows as the objects 21 through 23 visually and clearly, and it is easy for the user to individually realize three vectors represented by the three arrows.

A vector is a value associated with a position on a model, so it is desirable that an amount by which an object is moved be small. It is assumed that in order to efficiently prevent objects from overlapping, the simulation apparatus 100 utilizes a Fibonacci spiral.

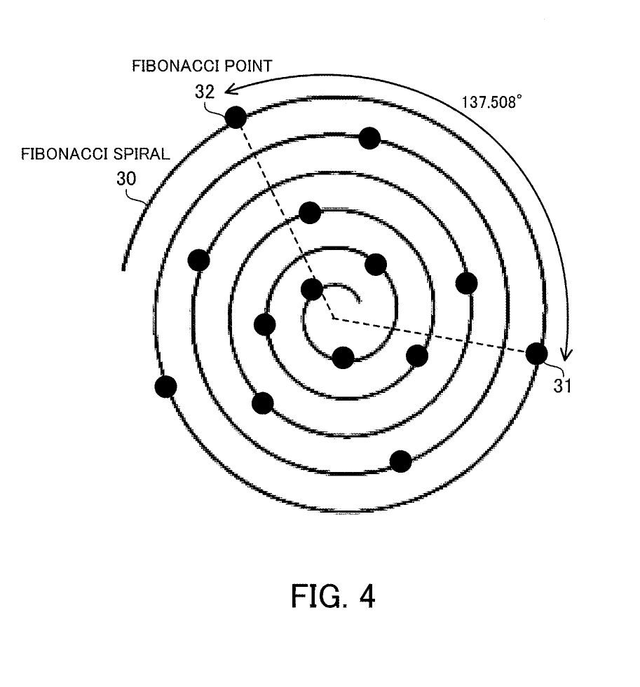

FIG. 4 illustrates an example of a Fibonacci spiral and a Fibonacci point.

If there exists an area in which object density is high in an image in which vector data is visualized, then the simulation apparatus 100 moves each object to a Fibonacci point nearest it and regenerates an image. A Fibonacci point is a point which forms a Fibonacci spiral 30. The Fibonacci spiral 30 is a spiral on which each time about a 137.508° (=golden angle φ) turn is made, the distance from the center increases. A central angle between a Fibonacci point (Fibonacci point 31, for example) and the next Fibonacci point (Fibonacci point 32, for example) on the Fibonacci spiral 30 is the golden angle φ (=about 137.508°).

As indicated by

$${R}_{g} = {lim}_{n \to ∞} \frac{{A}_{n}}{{A}_{n - 1}} = \frac{1 + \sqrt{5}}{2} \qquad ( 1 )$$

the golden ratio R_{g} is calculated as the limit of the ratio of an nth term (Aₙ) to an (n−1)th term (Aₙ₋₁) of a Fibonacci sequence. The golden ratio R_{g} is also calculated as a positive solution of x²−x−1=0. The golden angle φ is a smaller angle of angles obtained by dividing 360° by the ratio of 1 to R_{g}. In the natural world the leaves of plants may come out while revolving by the golden angle φ round the stems. The reason for this is that if the positions of leaves are shifted by the golden angle φ, the possibility that a lower leaf will be hidden from above by an upper leaf decreases and that the number of leaves which receive sunlight is maximized. Accordingly, the simulation apparatus 100 utilizes this property of the Fibonacci spiral 30. That is to say, the simulation apparatus 100 moves an object to a Fibonacci point so that when a set of objects is observed from any direction, objects will overlap less.

For example, the center of a model area to be drawn is considered as the center of the Fibonacci spiral 30. The simulation apparatus 100 calculates a plurality of Fibonacci points (about hundred to several hundred Fibonacci points, for example), with the set center as reference, in accordance with:

x=r\sqrt{k} sin(φk)

y=r\sqrt{k} cos(φk)

z=z₀ (2)

where k is a natural number and is an identification number of a Fibonacci point given is ascending order of the distance from the center of the Fibonacci spiral 30. A Fibonacci point whose identification number is 1 is the closest to the center. A Fibonacci point whose identification number is 2 is the second closest to the center and is obtained by turning the Fibonacci point whose identification number is 1 by the golden angle φ (=about 137.508°).

In the second embodiment a z component of the coordinates of a Fibonacci point is fixed at z₀. That is to say, the simulation apparatus 100 arranges the plurality of Fibonacci points on the x-y plane at z=z₀. Furthermore, three-dimensional coordinates calculated in accordance with expression (2) are relative coordinates to the center of the Fibonacci spiral 30. Accordingly, absolute coordinates in model space are calculated by adding the coordinates of the center of the Fibonacci spiral 30 to relative coordinates calculated in accordance with expression (2).

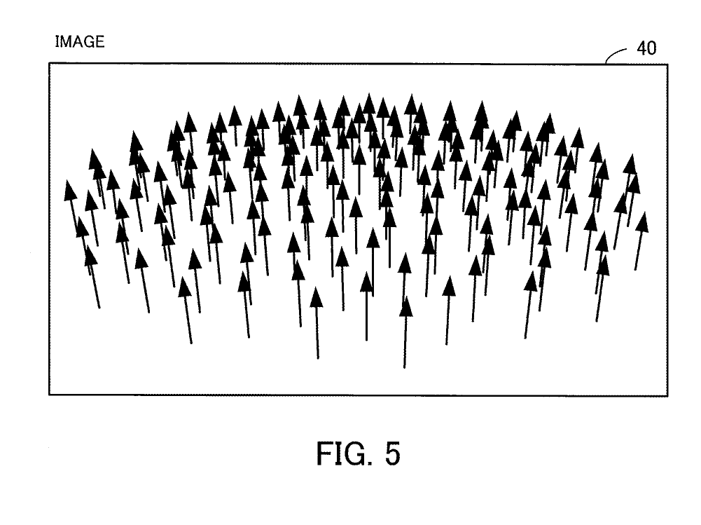

FIG. 5 illustrates an example of the display of rearranged objects.

An image 40 is obtained by visualizing vector data including 150 vectors. The image 40 is displayed on the display 111. The simulation apparatus 100 calculates more than 149 Fibonacci points which form a Fibonacci spiral, and moves each of 150 objects from its original position to the nearest Fibonacci point. As illustrated in FIG. 5, even if many objects are close, an overlap between objects is minimized by utilizing the Fibonacci spiral. This makes it possible to grasp the direction and length of an object distant from the camera and to easily realize the distribution of vectors.

The visualization function of the simulation apparatus 100 will now be described.

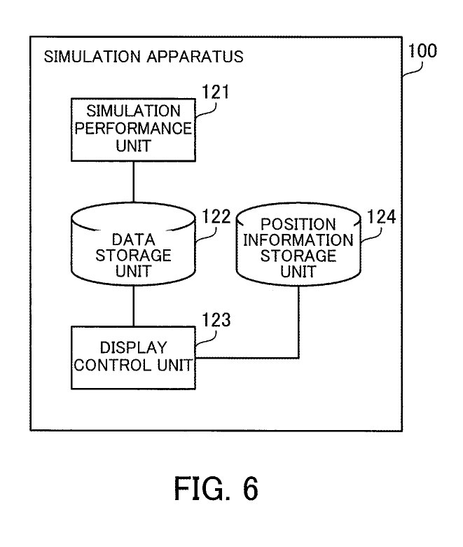

FIG. 6 is a block diagram which illustrates an example of the function of the simulation apparatus.

The simulation apparatus 100 includes a simulation performance unit 121, a data storage unit 122, a display control unit 123, and a position information storage unit 124. The simulation performance unit 121 and the display control unit 123 are realized as, for example, a module of a program executed by the CPU 101. The data storage unit 122 and the position information storage unit 124 are realized as, for example, a storage area secured in the RAM 102 or the HDD 103.

The simulation performance unit 121 acquires from a user a model indicative of the shape and the like of a body to be analyzed. The simulation performance unit 121 then performs a scientific technology simulation on the acquired model. For example, the simulation performance unit 121 calculates the distribution of a physical amount, such as stress or magnetic force, on the surface of or inside the body.

The data storage unit 122 stores a simulation result outputted from the simulation performance unit 121. The simulation result is vector data in which a plurality of positions on the model are associated with a plurality of vectors as physical amounts. A format in which a vector at each of a plurality of discrete positions is indicated or a format in which the distribution of continuous vectors on a plane or in space is indicated may be adopted for the vector data outputted from the simulation performance unit 121. In the latter case, when the vector data is visualized as described later, vectors at a plurality of discrete positions are extracted (sampled) from the vector data.

The display control unit 123 visualizes vector data stored in the data storage unit 122. The display control unit 123 generates a plurality of objects corresponding to a plurality of vectors indicated in the vector data. For example, the objects are arrows which differ in shape according to the directions and magnitude of the vectors. First the display control unit 123 arranges the plurality of objects at original positions indicated in the vector data, and generates an image obtained at the time of viewing the plurality of objects from an observation point. A user may designate the observation point at which the camera is arranged.

If there is no area in the image in which object density is high, then the display control unit 123 makes the display 111 display the generated image. On the other hand, if there is an area in the image in which object density is high, then the display control unit 123 changes the arrangement of the objects and regenerates an image. At this time the display control unit 123 calculates in the above way a plurality of Fibonacci points which form a Fibonacci spiral, and moves the objects with the Fibonacci points as reference. The display control unit 123 makes the display 111 display the regenerated image.

The position information storage unit 124 stores the coordinates of Fibonacci points calculated by the display control unit 123. Information stored in the position information storage unit 124 is referred to according to circumstances by the display control unit 123 to visualize vector data.

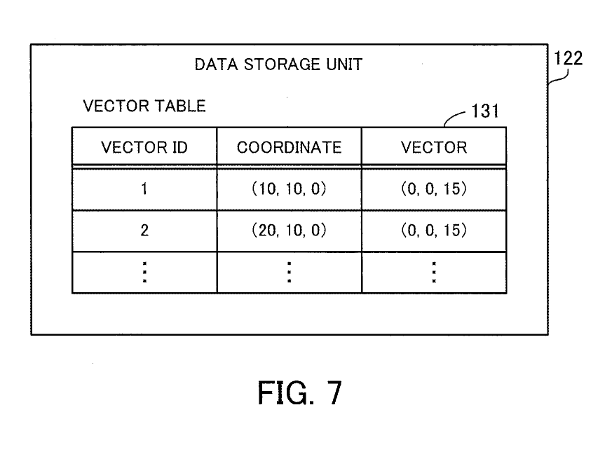

FIG. 7 illustrates an example of a vector table.

Vector data as a simulation result is registered in a vector table 131. The vector table 131 is stored in the data storage unit 122. The vector table 131 includes Vector ID, Coordinate, and Vector items.

Vector ID is an identification number which is a natural number and by which a vector is identified. Vector ID may also be used as object ID by which an object corresponding to a vector is identified at visualization time. Three-dimensional coordinates (combination of an x coordinate, a y coordinate, and a z coordinate) indicative of the position of a vector on a model are registered in the Coordinate item. A three-dimensional vector (combination of an x component, a y component, and a z component) indicative of a physical amount, such as stress or magnetic force, is registered in the Vector item.

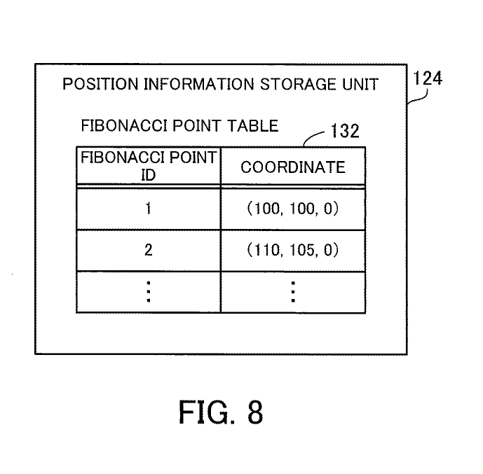

FIG. 8 illustrates an example of a Fibonacci point table.

Information regarding a Fibonacci point calculated at visualization time is registered in a Fibonacci point table 132. The Fibonacci point table 132 is stored in the position information storage unit 124. The Fibonacci point table 132 includes Fibonacci Point ID and Coordinate items.

Fibonacci point ID is an identification number which is a natural number and by which a Fibonacci point calculated by the display control unit 123 is identified. Fibonacci point ID is given to a Fibonacci point in ascending order of the distance from the center of a Fibonacci spiral. Three-dimensional coordinates (combination of an x coordinate, a y coordinate, and a z coordinate) indicative of the position of a Fibonacci point in a model are registered in the Coordinate item.

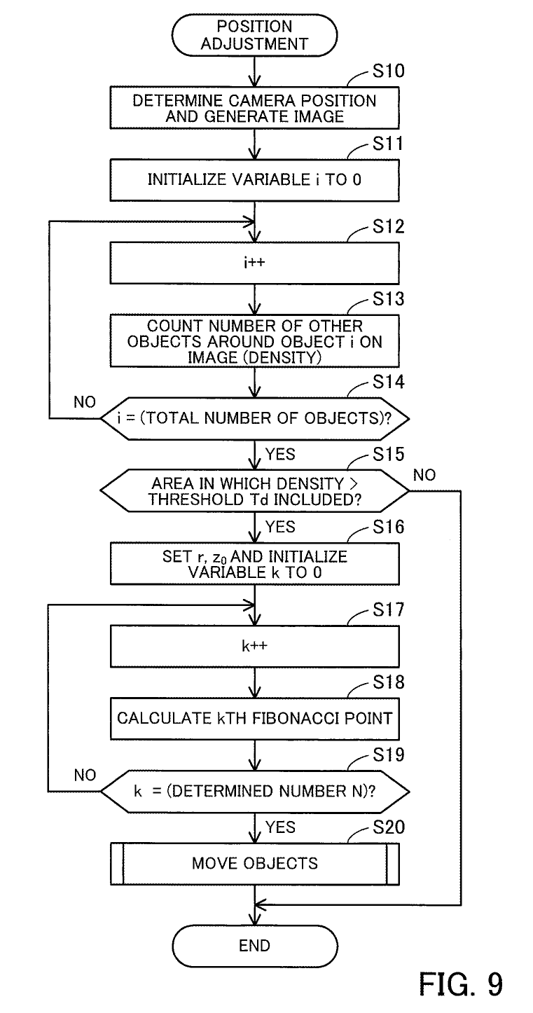

FIG. 9 is a flow chart of an example of a procedure for position adjustment.

(S10) The display control unit 123 reads out vector data from the data storage unit 122. The display control unit 123 generates a plurality of objects corresponding to a plurality of vectors included in the vector data (arrows having shapes corresponding to the directions and magnitude of vectors included in the vector data, for example), and arranges the plurality of objects at positions on a model indicated by coordinates included in the vector data. Furthermore, the display control unit 123 arranges the camera over the model. The position of the camera may be designated by a user or be calculated by the display control unit 123 in accordance with a determined rule. The display control unit 123 then generates an image (image before position adjustment) obtained at the time of viewing the set of objects from the camera.

(S11) The display control unit 123 defines a variable i indicative of object ID (=vector ID). The display control unit 123 then initializes the value of the variable i to zero.

(S12) The display control unit 123 increments (adds one to) the value of the variable i.

(S13) The display control unit 123 selects an object (object i) whose object ID is i from the image which the display control unit 123 generates in step S10. The display control unit 123 extracts an area around the object i in the image corresponding to d pixels and searches for other objects which appear in the extracted area. The pixel number d may be set in advance by the display control unit 123 or be designated by the user. The display control unit 123 counts the number of the other objects which it detects, and holds the number of the other objects as density.

(S14) The display control unit 123 determines whether or not the value of the variable i has reached the total number of the objects which it arranges on the model in step S10 (that is to say, the total number of the vectors included in the vector data). If the value of the variable i has reached the total number of the objects, then the display control unit 123 proceeds to step S15. If the value of the variable i is smaller than the total number of the objects, then the display control unit 123 proceeds to step S12.

(S15) The display control unit 123 determines whether or not the image generated in step S10 includes an area in which the density calculated in step S13 exceeds a threshold Td. The threshold Td may be set in advance in the display control unit 123, be designated by the user, or be calculated by the display control unit 123 according to the total number of the objects or the size of the image. If the image generated in step S10 includes an area in which the density calculated in step S13 exceeds the threshold Td, then the display control unit 123 proceeds to step S16. If the image generated in step S10 does not include an area in which the density calculated in step S13 exceeds the threshold Td, then the position adjustment ends.

(S16) The display control unit 123 sets the parameters r and z₀ in the above expression (2). The user may designate the parameters r and z₀. Furthermore, the display control unit 123 may calculate the parameter r according to the total number of the objects or the like. In addition, the display control unit 123 defines a variable k indicative of Fibonacci point ID and initializes the value of the variable k to zero.

(S17) The display control unit 123 increments the value of the variable k.

(S18) The display control unit 123 calculates a kth Fibonacci point by the use of the above expression (2) and records the coordinates of the calculated Fibonacci point in the position information storage unit 124.

(S19) The display control unit 123 determines whether or not the value of the variable k has reached a determined number N indicative of the total number of Fibonacci points. The determined number N may be set in advance in the display control unit 123, be designated by the user, or be calculated by the display control unit 123 according to the total number of the objects or the like. If the value of the variable k has reached the determined number N, then the display control unit 123 proceeds to step S20. If the value of the variable k is smaller than the determined number N, then the display control unit 123 proceeds to step S17.

(S20) On the basis of the Fibonacci point calculated in step S18, the display control unit 123 moves at least part of the objects generated in step S10. The display control unit 123 then generates an image (image after the position adjustment) obtained at the time of viewing the set of objects from the camera arranged in step S10, and makes the display 111 display the generated image. The details of a method for object movement will be described later.

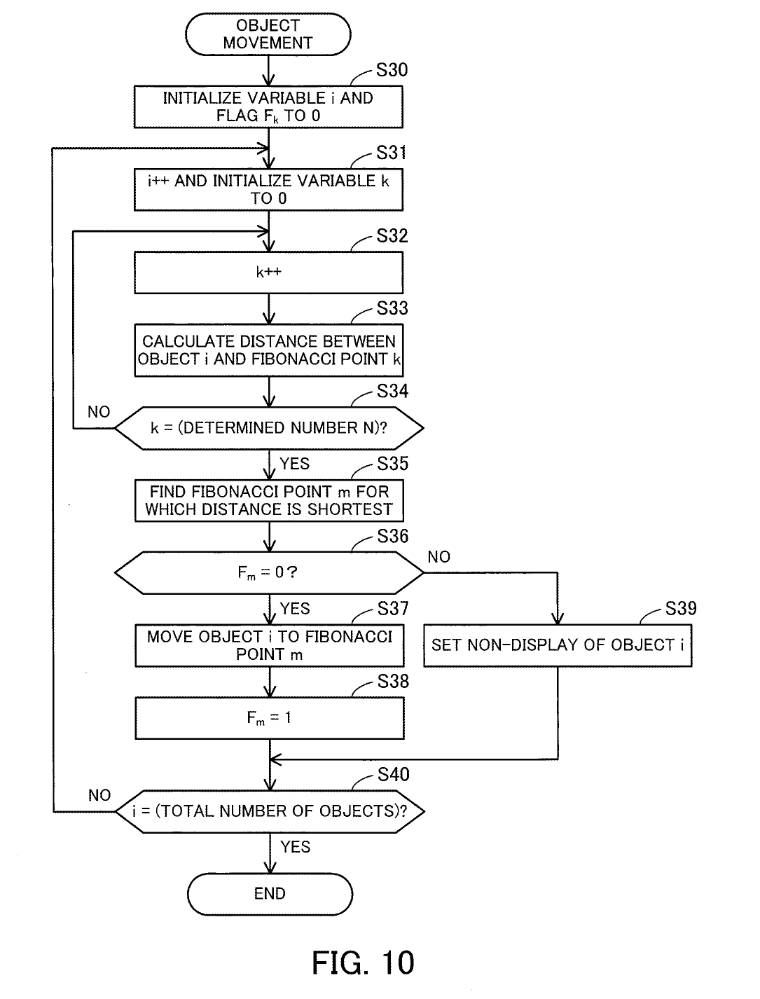

FIG. 10 is a flow chart of an example of a procedure for object movement.

The process indicated by this flow chart is performed in the above step S20.

(S30) The display control unit 123 initializes the value of the above variable i to zero. Furthermore, the display control unit 123 defines flags F₁, F₂, . . . , and F_{N} corresponding to the Fibonacci point ID 1, 2, . . . , and N, respectively, and initializes the flags F₁, F₂, . . . , and F_{N} to zero.

(S31) The display control unit 123 increments the value of the variable i. Furthermore, the display control unit 123 initializes the value of the above variable k to zero.

(S32) The display control unit 123 increments the value of the variable k.

(S33) The display control unit 123 calculates the distance on the model between the object i and a Fibonacci point (Fibonacci point k) whose Fibonacci point ID is k.

(S34) The display control unit 123 determines whether or not the value of the variable k has reached the determined number N indicative of the total number of the Fibonacci points. If the value of the variable k has reached the determined number N, then the display control unit 123 proceeds to step S35. If the value of the variable k is smaller than the determined number N, then the display control unit 123 proceeds to step S32.

(S35) The display control unit 123 finds a Fibonacci point m, of the Fibonacci points whose Fibonacci point ID is 1, 2, . . . , and N, for which the distance calculated in step S33 is the shortest.

(S36) The display control unit 123 determines whether or not Fₘ is zero. Fₘ=0 indicates that an object is not yet arranged at the Fibonacci point m. Fₘ=1 indicates that an object was already arranged at the Fibonacci point m. If Fₘ is zero, then the display control unit 123 proceeds to step S37. If Fₘ is one, then the display control unit 123 proceeds to step S39.

(S37) The display control unit 123 moves the object i to the Fibonacci point m. That is to say, if another object is not arranged at the Fibonacci point m nearest the original position of the object i, then the display control unit 123 arranges the object i at the Fibonacci point m.

(S38) The display control unit 123 changes Fₘ to one. The display control unit 123 then proceeds to step S40.

(S39) The display control unit 123 sets non-display of the object i. As a result, the object i is not arranged on the model and does not appear in an image. That is to say, if another object was already arranged at the Fibonacci point m nearest the original position of the object i, then the display control unit 123 deletes the object i from the model and does not display the object i.

(S40) The display control unit 123 determines whether or not the value of the variable i has reached the total number of the objects. If the value of the variable i has reached the total number of the objects, then the object movement ends. If the value of the variable i is smaller than the total number of the objects, then the display control unit 123 proceeds to step S31.

A modification of object movement will now be described. In the above object movement each object is arranged at a Fibonacci point. On the other hand, Fibonacci points are considered as reference, but an object may be arranged at a position other than a Fibonacci point.

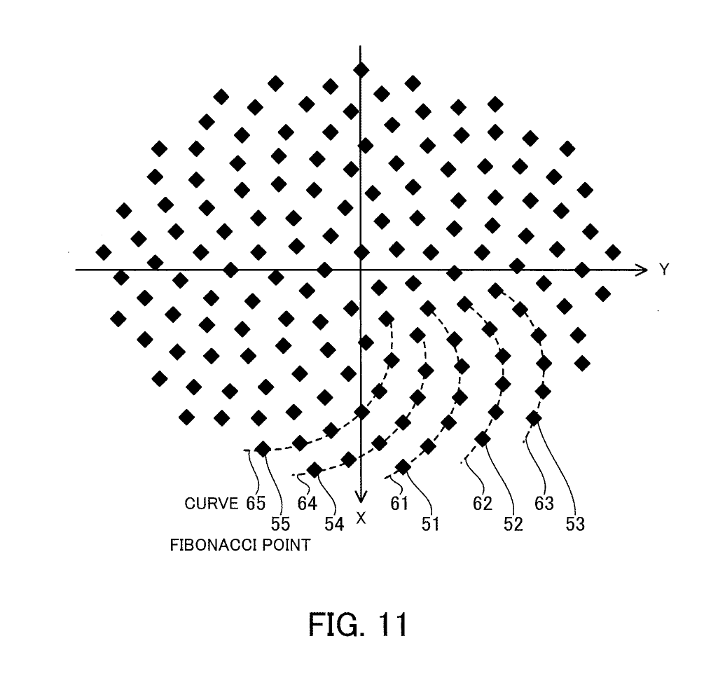

FIG. 11 illustrates an example of a curve which connects Fibonacci points.

If Fibonacci points are calculated in accordance with the above expression (2), then twenty-one curves which extend radially from the center of a Fibonacci spiral are formed. Each radial curve appears by selecting Fibonacci points at intervals of 21 Fibonacci points, that is to say, by connecting in order a Fibonacci point and a Fibonacci point twenty-one before or after it by a line. With the modification of object movement, the simulation apparatus 100 moves each object onto a curve nearest its original position. In this case, a position to which an object is moved may not be a Fibonacci point.

The twenty-one curves are calculated in the following way. The simulation apparatus 100 selects a line the most distant from the camera from an area in which there are objects that the simulation apparatus 100 makes appear in an image, and sets the center (center in the horizontal direction from the camera) of the line as the center of the Fibonacci spiral. The simulation apparatus 100 calculates Fibonacci points with the center as reference.

Next, the simulation apparatus 100 selects a Fibonacci point nearest the camera. For example, if N=150, then there is a strong possibility that a Fibonacci point nearest the camera will be a Fibonacci point whose Fibonacci point ID is 140 or so. If N=300, then there is a strong possibility that a Fibonacci point nearest the camera will be a Fibonacci point whose Fibonacci point ID is 185 or so. The simulation apparatus 100 connects the selected Fibonacci point and a Fibonacci point (whose Fibonacci point ID is smaller than that of the selected Fibonacci point by twenty-one) twenty-one before it by a line. The simulation apparatus 100 repeats this operation toward the center of the Fibonacci spiral to calculate one curve. The simulation apparatus 100 calculates in the same way a curve next to the calculated curve on the right side. Furthermore, the simulation apparatus 100 calculates in the same way a curve next to the calculated curve on the left side. By doing so, the twenty-one curves which extend radially from the center of the Fibonacci spiral are calculated.

In FIG. 11, as an example, the simulation apparatus 100 selects a Fibonacci point 51 nearest the camera. The simulation apparatus 100 starts with the Fibonacci point 51 and traces a Fibonacci point twenty-one before the Fibonacci point 51. The simulation apparatus 100 repeats this operation in order. By doing so, the simulation apparatus 100 calculates a curve 61. Next, the simulation apparatus 100 selects a Fibonacci point 52 nearest the camera on the right side of the curve 61. The simulation apparatus 100 starts with the Fibonacci point 52 and traces in order a Fibonacci point twenty-one before. By doing so, the simulation apparatus 100 calculates a curve 62. Next, the simulation apparatus 100 selects a Fibonacci point 53 nearest the camera on the right side of the curve 62. The simulation apparatus 100 starts with the Fibonacci point 53 and traces in order a Fibonacci point twenty-one before. By doing so, the simulation apparatus 100 calculates a curve 63.

If there is no Fibonacci point on the right side which is not yet selected, then the simulation apparatus 100 selects a Fibonacci point 54 nearest the camera on the left side of the curve 61. The simulation apparatus 100 starts with the Fibonacci point 54 and traces a Fibonacci point twenty-one before the Fibonacci point 54. The simulation apparatus 100 repeats this operation in order. By doing so, the simulation apparatus 100 calculates a curve 64. Next, the simulation apparatus 100 selects a Fibonacci point 55 nearest the camera on the left side of the curve 64. The simulation apparatus 100 starts with the Fibonacci point 55 and traces in order a Fibonacci point twenty-one before. By doing so, the simulation apparatus 100 calculates a curve 65. All the curves are calculated in this way.

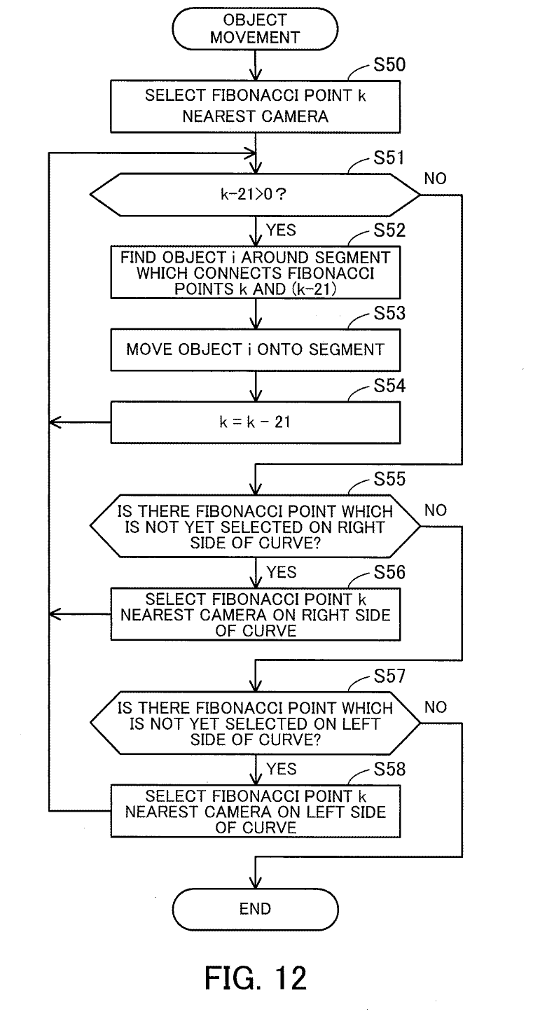

FIG. 12 is a flow chart of an example of another procedure for object movement.

The process indicated by this flow chart is performed in the above step S20. If the above movement method indicated in FIG. 10 is used, it is desirable that the center of a Fibonacci spiral be the center of an area in which there are objects. On the other hand, if the movement method indicated in FIG. 12 is used, it is desirable that the center of a Fibonacci spiral be a center in the horizontal direction from the camera included in a line the most distant from the camera in an area in which there are objects (intersection of the line and the line of sight of the camera).

(S50) The display control unit 123 selects a Fibonacci point k (whose Fibonacci point ID is k) nearest the camera from among Fibonacci points whose Fibonacci point ID is 1, 2, . . . , and N.

(S51) The display control unit 123 determines whether or not there is a Fibonacci point twenty-one before the Fibonacci point k selected in step S50 or S54, that is to say, whether or not k−21>0 holds. If there is a Fibonacci point twenty-one before the Fibonacci point k, then the display control unit 123 proceeds to step S52. If there is no Fibonacci point twenty-one before the Fibonacci point k, then the display control unit 123 proceeds to step S55.

(S52) The display control unit 123 calculates a segment which connects the Fibonacci point k and the Fibonacci point (k−21). This segment may approximately be considered as a straight line. The display control unit 123 then searches for an object within a determined range from the calculated segment. The display control unit 123 may search for all objects within the determined range from the calculated segment or may search for only one object nearest the calculated segment within the determined range from the calculated segment. It is assumed that the display control unit 123 finds an object i.

(S53) The display control unit 123 moves the object i which it finds in step S52 onto the segment which it calculates in step S52. If the display control unit 123 finds more than one object in step S52, it is desirable to arrange these objects at different positions on the segment.

(S54) The display control unit 123 reduces the value of the variable k by twenty-one. That is to say, the display control unit 123 selects a Fibonacci point twenty-one before the Fibonacci point k. The display control unit 123 then proceeds to step S51.

(S55) The display control unit 123 determines whether or not there is a Fibonacci point which is not yet selected on the right side from the camera of a curve calculated just before. If there is a Fibonacci point which is not yet selected on the right side of the curve calculated just before, then the display control unit 123 proceeds to step S56. If there is no Fibonacci point which is not yet selected on the right side of the curve calculated just before, then the display control unit 123 proceeds to step S57.

(S56) The display control unit 123 selects the Fibonacci point k nearest the camera from among Fibonacci points which are not yet selected on the right side of the curve calculated just before. The display control unit 123 then proceeds to step S51. By doing so, a curve is calculated with the Fibonacci point k as reference.

(S57) The display control unit 123 determines whether or not there is a Fibonacci point which is not yet selected on the left side from the camera of the curve calculated just before. If there is a Fibonacci point which is not yet selected on the left side of the curve calculated just before, then the display control unit 123 proceeds to step S58. If there is no Fibonacci point which is not yet selected on the left side of the curve calculated just before, then the object movement ends.

(S58) The display control unit 123 selects the Fibonacci point k nearest the camera from among Fibonacci points which are not yet selected on the left side of the curve calculated just before. The display control unit 123 then proceeds to step S51. By doing so, a curve is calculated with the Fibonacci point k as reference.

With the simulation apparatus 100 according to the second embodiment a plurality of Fibonacci points which form a Fibonacci spiral are calculated if vector data is visualized. Objects (such as arrows) corresponding to vectors included in the vector data are then moved from positions indicated in the vector data to Fibonacci points. As a result, when a set of objects is observed from any direction, the possibility that objects will be visible in an image in a state in which they overlap is reduced on the basis of the property of the Fibonacci spiral. This makes it easy to realize the direction and magnitude of each vector, and the visibility of a visualized result is improved.

In addition, an object may be moved onto one of a plurality of curves which extend radially from the center of a Fibonacci spiral. This also reduces the possibility that objects will be visible in an image in a state in which they overlap. In addition, the number of positions at which objects can be arranged is increased. Accordingly, even in an area in which object density is high, deletion of an object (setting non-display of an object) is avoided and the amount of information for a visualized result is maintained.

The information processing in the first embodiment is realized by making the simulation apparatus 10 execute a program. The information processing in the second embodiment is realized by making the simulation apparatus 100 execute a program.

The programs are recorded in a computer-readable record medium (such as the record medium 113). A magnetic disk, an optical disk, a magneto-optical disk, a semiconductor memory, or the like is used as a record medium. A magnetic disk may be an FD or an HDD. An optical disk may be a CD, a CD-R(Recordable)/RW(ReWritable), a DVD, or a DVD-R/RW. The programs may be recorded in portable record media and be distributed. In that case, the programs may be copied from a portable record medium to another record medium, such as an HDD, (HDD 103, for example) and be executed.

According to an aspect, visibility is improved when a plurality of objects indicative of vectors are displayed.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A non-transitory computer-readable storage medium storing a program that causes a computer to perform a process comprising:
acquiring vector data indicative of a vector at each of a plurality of positions on a model;
calculating a plurality of points on the model which are arranged spirally; and
changing, at the time of displaying a plurality of objects corresponding to a plurality of vectors indicated in the vector data, display positions of at least part of the plurality of objects from positions indicated in the vector data on the basis of the plurality of points calculated.

2. The non-transitory computer-readable storage medium according to claim 1, wherein the changing includes selecting a display position of each of the plurality of objects from among the plurality of points.

3. The non-transitory computer-readable storage medium according to claim 1, wherein the changing includes moving a display position of each of the plurality of objects onto one of a plurality of curves which extend radially from a center of a spiral along the plurality of points.

4. The non-transitory computer-readable storage medium according to claim 1, wherein the calculating includes calculating the plurality of points so that two adjacent points are a determined angle distant from each other.

5. A simulation apparatus comprising:
a memory which stores vector data indicative of a vector at each of a plurality of positions on a model; and
a processor which calculates a plurality of points on the model arranged spirally and which changes, at the time of displaying a plurality of objects corresponding to a plurality of vectors indicated in the vector data, display positions of at least part of the plurality of objects from positions indicated in the vector data on the basis of the plurality of points calculated.

6. A vector display method comprising:
acquiring, by a processor, vector data indicative of a vector at each of a plurality of positions on a model;
calculating, by the processor, a plurality of points on the model which are arranged spirally; and
changing, by the processor at the time of displaying a plurality of objects corresponding to a plurality of vectors indicated in the vector data, display positions of at least part of the plurality of objects from positions indicated in the vector data on the basis of the plurality of points calculated.
